(19) United States
(12) Patent Application Publication
(10) Pub. No.: US 2025/0375719 A1
(43) Pub. Date: Dec. 11, 2025

(54) DEAERATOR

(71) Applicant: DIC Corporation, Tokyo (JP)

(72) Inventors: Akira Sato, Ichihara-shi (JP); Kazuyasu Kawashima, Ichihara-shi (JP); Takaaki Fuse, Ichihara-shi (JP); Kazumi Oi, Ichihara-shi (JP)

(73) Assignee: DIC Corporation, Tokyo (JP)

(21) Appl. No.: 18/877,960

(22) PCT Filed: Jun. 22, 2023
(86) PCT No.: PCT/JP2023/023204

§ 371 Date: Dec. 20, 2024

(30) Foreign Application Priority Data
Jun. 27, 2022 (JP) 2022-102629

(51) Int. Cl. B01D 19/00; G01L 19/00

(52) U.S. Cl. CPC B01D 19/0036; B01D 19/0063; G01L 19/0023

(57) ABSTRACT

A deaerator includes a deaerating module having a tube unit having gas permeability, separating a fluid circulation space and a reduced-pressure space, vacuum piping connected to the deaerating module to be communicatively connected to the reduced-pressure space of the deaerating module, a discharge device connected to the vacuum piping to discharge a gas in the reduce-pressure space to the outside, and a detector connected to the vacuum piping to detect pressure. The detector includes a connection nozzle portion connected to the vacuum piping, a pressure introduction path extending from an opening formed at a tip of the connection nozzle portion to be communicatively connected to the vacuum piping, a pressure detection space communicatively connected to the pressure introduction path, and a pressure detection element arranged in the pressure detection space. The opening of the pressure introduction path is directed downward with respect to a horizontal direction.

### TECHNICAL FIELD

The present invention relates to a deaerator.

### BACKGROUND ART

PTL 1 discloses a deaerator used in a liquid chromatography device and the like.

### CITATION LIST

### Patent Literature

PTL 1: WO 2007/094242

### SUMMARY OF INVENTION

### Technical Problem

The deaerator described in PTL 1 includes a reduced-pressure space within a deaerating module provided with a tube unit and a discharge device (a pump) that are communicatively connected to each other by vacuum piping and is configured to deaerate a liquid circulating through the tube unit by activating the discharge device. This deaerator includes a detector (a pressure detection section) monitoring the degree of depressurization (the pressure) of the reduced-pressure space and controls the on and off of the discharge device when the degree of depressurization of the reduced-pressure space deviates from a certain value range.

The detector for use in the deaerator generally has a connection nozzle portion connected to the vacuum piping, a pressure introduction path extending from an opening formed at the tip of the connection nozzle portion and communicatively connected to the vacuum piping, a pressure detection space communicatively connected to the pressure introduction path, and a pressure detection element such as a diaphragm arranged in the pressure detection space. Thus, if condensation occurs inside the connection nozzle portion and inside the vacuum piping due to a temperature difference between the inside and outside of the connection nozzle portion and the vacuum piping, this condensed water may enter the pressure detection space from the pressure introduction path and come into contact with the pressure detection element. If liquid leaks from the tube unit to the reduced-pressure space due to deterioration of the tube unit or the like, leaking liquid, which is the liquid that has leaked, may travel through the vacuum piping, enter the pressure detection space from the pressure introduction path, and come into contact with the pressure detection element by the activation of the discharge device. When liquids such as the condensed water and the leaking liquid come into contact with the pressure detection element, the pressure detection element deteriorates or malfunctions, which is likely to cause defects in the detector.

Thus, an object of an aspect of the present invention is to provide a deaerator that can inhibit liquid from coming into contact with the pressure detection element of the detector.

### Solution to Problem

[1] A deaerator according to an aspect of the present invention includes a deaerating module having a tube unit having gas permeability, separating a fluid circulation space and a reduced-pressure space, vacuum piping connected to the deaerating module to be communicatively connected to the reduced-pressure space of the deaerating module, a discharge device connected to the vacuum piping to discharge a gas in the reduce-pressure space to the outside, and a detector connected to the vacuum piping to detect pressure, the detector including a connection nozzle portion connected to the vacuum piping, a pressure introduction path extending from an opening formed at a tip of the connection nozzle portion to be communicatively connected to the vacuum piping, a pressure detection space communicatively connected to the pressure introduction path, and a pressure detection element arranged in the pressure detection space, and the opening of the pressure introduction path being directed downward with respect to a horizontal direction.

In this deaerator, the pressure detection element of the detector is arranged in the pressure detection space communicatively connected to the vacuum piping via the pressure introduction path, and thus the degree of depressurization of the reduced-pressure space can be detected. The opening of the pressure introduction path is directed downward with respect to the horizontal direction, and thus even if condensed water (liquid) occurs in the pressure introduction path or condensed water occurring in the vacuum piping flows to the pressure introduction path, these condensed waters are easily discharged to the outside of the pressure introduction path from the opening by gravity. This can inhibit condensed water from coming into contact with the pressure detection element. Even if leaking liquid that has leaked from the tube unit to the reduced-pressure space travels through the vacuum piping and flows to the pressure introduction path by the activation of the discharge device, this leaking liquid is easily discharged to the outside of the pressure introduction path from the opening by gravity. This can inhibit the leaking liquid from coming into contact with the pressure detection element.

[2] In the deaerator according to [1], the opening of the pressure introduction path may be directed downward by 10° or more with respect to the horizontal direction. In this deaerator, the opening of the pressure introduction path is directed downward by 10° or more with respect to the horizontal direction, thus making it easier to discharge the liquid from the pressure introduction path.

[3] In the deaerator according to [1] or [2], the pressure introduction path may extend in a straight line. In this deaerator, the pressure introduction path extends in a straight line, thus making it easier to discharge the liquid from the pressure introduction path.

[4] In the deaerator according to any one of [1] to [3], a central axis line of the pressure introduction path directed from the pressure detection space toward the opening may be directed downward with respect to the horizontal direction. In this deaerator, the central axis line of the pressure introduction path directed from the pressure detection apace toward the opening is directed downward with respect to the horizontal direction, thus making it easier to discharge the liquid from the pressure introduction path.

[5] In the deaerator according to any one of [1] to [4], the pressure detection element may be arranged at a position overlapping the opening as viewed from an extension direction of the pressure introduction path. In this deaerator, the pressure detection element is arranged at the position overlapping the opening as viewed from the extension direction of the pressure introduction path, which can reduce the size of the detector and detect the pressure in the reduced-pressure space more efficiently.

[6] In the deaerator according to any one of [1] to [5], at least part of the vacuum piping may be a resin composition containing polyolefin and a styrene thermoplastic elastomer. In this deaerator, at least part of the vacuum piping is a resin composition containing a polyolefin and a styrene thermoplastic elastomer, which can provide excellent solvent resistance, chemical resistance, and durability. In addition, gas permeability can be reduced, and disconnection of the vacuum piping can be suppressed.

### Advantageous Effects of Invention

An aspect of the present invention can inhibit liquid from coming into contact with the pressure detection element of the detector.

### BRIEF DESCRIPTION OF DRAWINGS

FIG. 1 is a schematic plan view of a deaerator according to an embodiment of the present invention.

FIG. 2 is a schematic side view of the deaerator illustrated in FIG. 1.

FIG. 3 is a schematic cross-sectional view of an example of a deaerating module installed in the deaerator illustrated in FIG. 1.

FIG. 4 is an enlarged cross-sectional view of a section around a connector portion of the deaerator illustrated in FIG. 3.

FIG. 5 is an enlarged cross-sectional view of a section around a vibration isolating member of the deaerator illustrated in FIG. 1.

FIG. 6 is a schematic side view of a detector illustrated in FIG. 1.

FIG. 7 is a diagram for illustrating a direction in which an opening of a pressure introduction path is directed.

FIG. 8 is a schematic side view of a detector as another example.

FIG. 9 is a schematic side view of a deaerator as another example.

FIG. 10 is an enlarged cross-sectional view of a section around a vibration isolating member of the deaerator illustrated in FIG. 9.

FIG. 11 is a schematic side view of a deaerator as another example.

### DESCRIPTION OF EMBODIMENTS

A deaerator of an embodiment will be described in detail below with reference to the drawings. In all of the drawings, the same or corresponding parts are denoted by the same reference signs and an overlapping description will be omitted.

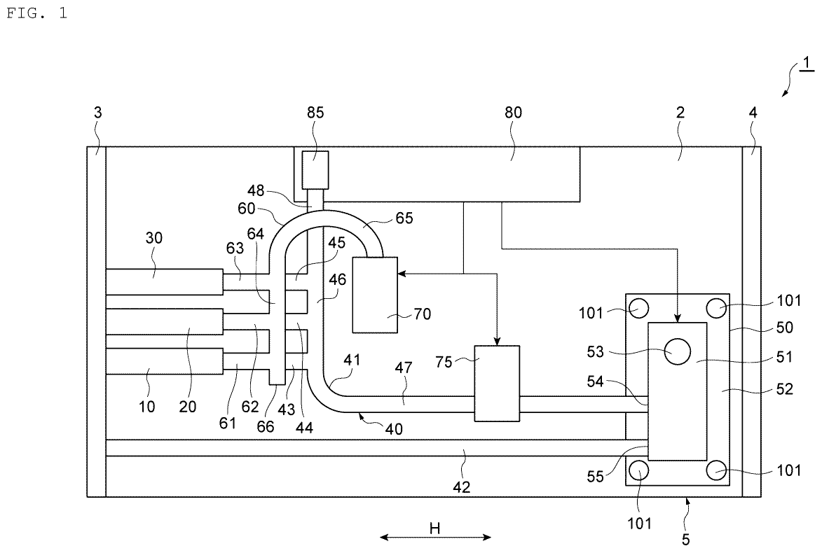

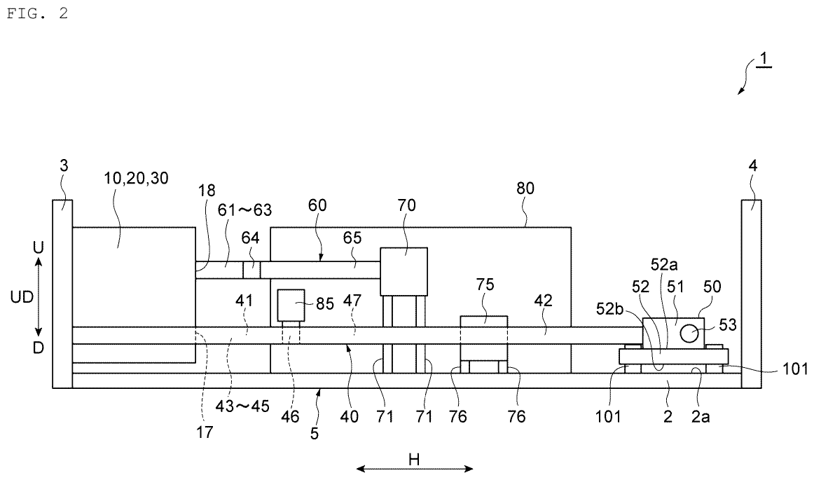

FIG. 1 is a schematic plan view of a deaerator according to an embodiment. FIG. 2 is a schematic side view of the deaerator illustrated in FIG. 1. The deaerator 1 illustrated in FIG. 1 and FIG. 2 is, for example, a deaerator for liquid chromatography and performs a deaerating process on a fluid to be tested in liquid chromatography. The deaerator 1 may be used for gas chromatography, biochemical analyzers, inkjet filling devices, and the like, as a matter of course. As illustrated in FIG. 1 and FIG. 2, the deaerator 1 includes a housing 5 having a bottom plate 2, a front plate 3, and a rear plate 4, deaerating modules 10, 20, and 30, vacuum piping 40, a discharge device 50, atmospheric release piping 60, an atmospheric release valve 70, a regulating valve 75, a control unit 80, and a detector 90.

The bottom plate 2 of the housing 5 defines the bottom of the deaerator 1. The front plate 3 of the housing 5 is erected from the bottom plate 2 to define the front of the deaerator 1. The rear plate 4 of the housing 5 is erected from the bottom plate 2 so as to face the front plate 3 behind the front plate 3 to define the rear of the deaerator 1. In the deaerator 1, the horizontal direction in the state in which the deaerator 1 is installed is referred to as a horizontal direction H, the up and down direction in the state in which the deaerator 1 is installed is referred to as an up and down direction UD, upward in the state in which the deaerator 1 is installed is referred to as upward U, and downward in the state in which the deaerator 1 is installed is referred to as downward D. The horizontal direction H is, for example, a direction in which the bottom plate 2 extends. The vertical direction UD is, for example, a direction orthogonal to the bottom plate 2. Upward U is, for example, a direction in which the front plate 3 and the rear plate 4 are erected on the bottom plate 2. Downward D is, for example, a direction opposite the direction in which the front plate 3 and the rear plate 4 are erected on the bottom plate 2.

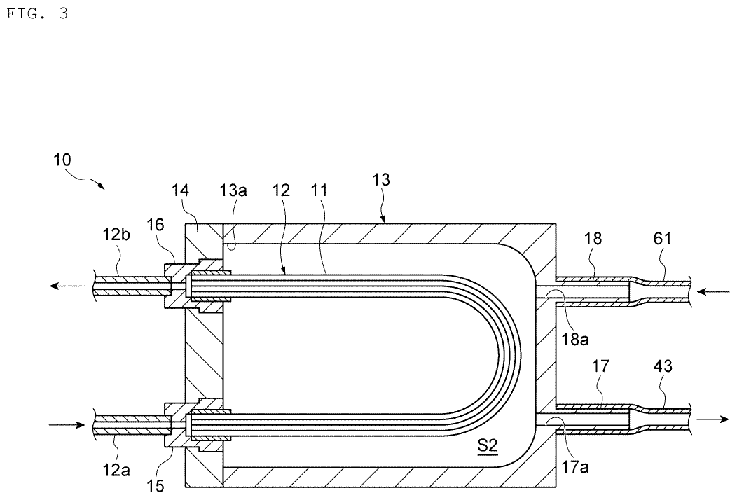

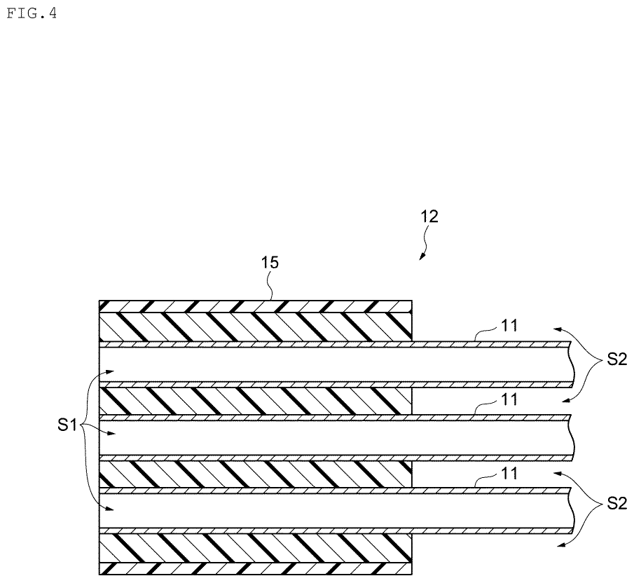

The deaerating modules 10, 20, and 30 have a configuration, for example, illustrated in FIG. 3. FIG. 3 is a schematic cross-sectional view of an example of a deaerating module installed in the deaerator illustrated in FIG. 1. FIG. 4 is an enlarged cross-sectional view of a section around a connector portion of the deaerating module illustrated in FIG. 3. FIG. 3 illustrates a configuration of the deaerating module 10 as an example, and the other deaerating modules 20 and 30 have a similar configuration. As illustrated in FIG. 3 and FIG. 4, the deaerating module 10 has a tube unit 12 with a plurality of tubes 11 bundled at both ends, each tube 11 defining a fluid circulation space S1 in the inside, a housing 13 that accommodates the tube unit 12, a lid 14 that hermetically seals an opening 13a of the housing 13, a connector portion 15 and a connector portion 16 that connect and fix the tube unit 12 penetrating through the lid 14, and a discharge nozzle portion 17 and a release nozzle portion 18 protruding from the housing 13. The discharge nozzle portion 17 is formed with a discharge port 17a communicatively connected to the reduced-pressure space S2, and the release nozzle portion 18 is formed with a release port 18a communicatively connected to the reduced-pressure space S2.

In the deaerating module 10, the tube unit 12 which is gas permeable membranes having gas permeability divides the inside of the housing 13 into the fluid circulation space S1 which is an interior space of each of the tubes 11 of the tube unit 12 and the reduced-pressure space S2 which is a space outside the tube unit 12. The fluid circulation space S1 is a region where a liquid is supplied, and the liquid introduced from an inlet port 12a of the tube unit 12 is supplied to a discharge port 12b. The reduced-pressure space S2 is a region where the internal gas is sucked. In the deaerating module 10, a liquid is supplied to the fluid circulation space S1 which is the interior space of each of the tubes 11, and a gas is sucked from the reduced-pressure space S2 outside the tubes 11, whereby the liquid supplied to the tube unit 12 is deaerated.

Each of the tubes 11 that constitute the tube unit 12 is a tubular membrane (gas permeable membrane) that allows a gas to pass through but does not allow a liquid to pass through (see FIG. 4). The material, membrane shape, membrane form, and the like of the tube 11 are not limited. Examples of the material of the tube 11 include fluororesins such as polytetrafluoroethylene (PTFE), tetrafluoroethylene-perfluoroalkyl vinyl ether copolymer (PFA), tetrafluoroethylene-hexafluoropropylene copolymer (FEP), tetrafluoroethylene-ethylene copolymer (ethylene copolymer) (ETFE), polychlorotrifluoroethylene (PCTFE), amorphous fluoropolymer (AF), and polyvinylidene fluoride (PVDF), polypropylene (PP), polymethylpentene (PMP), silicone, polyimide, and polyamide. An example of the amorphous fluoropolymer may be Teflon (registered trademark) AF.

In the deaerator 1, three deaerating modules 10, 20, and 30 in such a manner are arranged, but one deaerating module may be arranged, two deaerating modules may be arranged, or four or more deaerating modules may be arranged.

As illustrated in FIG. 1 and FIG. 2, the vacuum piping 40 is a member for discharging the gas in the reduced-pressure spaces S2 to the outside. The vacuum piping 40 includes a suction pipe section 41 and a discharge pipe section 42.

The suction pipe section 41 is connected to the deaerating modules 10, 20, and 30 to be communicatively connected to the respective reduced-pressure spaces S2 of the deaerating modules 10, 20, and 30. The suction pipe section 41 has discharge piping sections 43, 44, and 45 continuous to the respective discharge ports 17 of the deaerating modules 10, 20, and 30, a discharge assembly section 46 for assembling the discharge piping sections 43, 44, and 45, a piping section 47 connecting the discharge assembly section 46 to the discharge device 50, and a detection piping section 48 communicatively connecting the discharge assembly section 46 to the detector 90. As will be described later, the detector 90 is a barometric pressure sensor that detects the degree of depressurization (the pressure) in the respective reduced-pressure spaces S2 of the deaerating modules 10, 20, and 30 and is provided, for example, in the control unit 80.

The discharge pipe section 42 is connected to the discharge device 50 in order to discharge the gas sent out from the discharge device 50 to the outside of the deaerator 1. The end of the discharge pipe section 42 opposite the discharge device 50 is mounted on the front plate 3 and opens to the outside of the deaerator 1 in front of the front plate 3.

At least some of the suction pipe section 41 (the discharge piping sections 43, 44, and 45, the discharge assembly section 46, the piping section 47, and the detection piping section 48) and the discharge pipe section 42 that constitute the vacuum piping 40 are formed of, for example, resin tubes. All or almost all (e.g., excluding a joint portion) of the constituent members of the vacuum piping 40 may be formed of resin tubes. In other words, a plurality of tubes may be coupled using joint members or the like to constitute the vacuum piping 40. Such a tube is resistant to a solvent used in liquid chromatography and is formed of piping, for example, having a rubber hardness of preferably in the range of 70±30 degrees and an oxygen permeability of 6000 cc (STP) cm/cm²/sec/cmHg×10⁻¹⁰ or less. The rubber hardness is preferably in the range of 70±30 degrees. In order to achieve both of appropriate flexibility to prevent loosening or disconnection at a joint portion and appropriate durability to suppress deformation, crushing, or blockage of the tubes, the lower limit is more preferably 50 degrees or more, even more preferably 55 degrees or more, particularly preferably 60 degrees or more, and the upper limit is more preferably 95 degrees or less, even more preferably 80 degrees or less, and particularly preferably 75 degrees or less. It is noted that the rubber hardness represents Shore A and can be measured, for example, with a durometer (type A) in accordance with JIS K7312 (1996). In terms of excellent durability, the oxygen permeability is preferably 6000 cc (STP) cm/cm²/sec/cmHg×10⁻¹⁰ or less, more preferably 3000 cc (STP) cm/cm²/sec/cmHg×10⁻¹⁰ or less, even more preferably 1000 cc (STP) cm/cm²/sec/cmHg×10⁻¹⁰ or less, particularly preferably 500 cc (STP) cm/cm²/sec/cmHg×10⁻¹⁰ or less, and preferably 0.1 cc (STP) cm/cm²/sec/cmHg×10⁻¹⁰ or more, more preferably 10 cc (STP) cm/cm²/sec/cmHg×10⁻¹⁰ or more. It is noted that the oxygen permeability represents the oxygen transmission rate and can be measured, for example, in accordance with the ASTM D 1434 Standard.

The material of the tubes that constitute the vacuum piping 40 is not limited as long as it has the properties described above. Examples include vinyl chloride, silicone rubber; polyamides (nylon) such as nylon 6, nylon 66, nylon 11, and nylon 12; polyurethanes; polyolefins such as polyethylene such as low-density polyethylene and linear low-density polyethylene, and polypropylene; fluororesins such as FEP, PFA, ETFE, and PTFE; and thermoplastic elastomers such as polyester thermoplastic elastomers, styrene thermoplastic elastomers, and olefin thermoplastic elastomers. One or two or more kinds of these can be used. Among the materials described above, a resin composition containing polyolefin and a thermoplastic elastomer is more preferred as the material of the tubes that constitute the vacuum piping 40, and a resin composition containing polyolefin and a styrene thermoplastic elastomer is even more preferred.

The vacuum piping 40 formed of the resin composition containing polyolefin and a thermoplastic elastomer described above has not only excellent solvent resistance but also low gas permeability. The vacuum piping 40 formed of the resin composition containing polyolefin and a thermoplastic elastomer described above has appropriate flexibility and has excellent durability, because loosening or disconnection at a joint portion of the discharge assembly section 46 during deaerating operation is prevented and deformation, crushing, or blockage of the tubes is suppressed. Further, the deaerator 1 according to the present embodiment includes a plurality of deaerating modules and has many joint configurations such as joint portions between the vacuum piping 40 and the deaerating modules 10, 20, and 30 and joint portions of the discharge assembly section 46 with other parts, and the configuration having the tubes with such flexibility and durability can also improve the long-term reliability of the deaerator.

The styrene thermoplastic elastomer used for the vacuum piping 40 is a copolymer having at least one styrene block (hard segment) and at least one elastomer block. Vinyl-polydiene, polyisoprene, polybutadiene, polyethylene, polychloroprene, poly(2,3-dimethylbutadiene), or the like is preferably used as the elastomer block. The elastomer block may be hydrogenated. It is preferable that the elastomer block is hydrogenated, because if so, the solvent resistance and the chemical-resistant performance tend to be higher. Specific examples of the styrene thermoplastic elastomer include styrene-vinylisoprene-styrene triblock copolymer (SIS), styrene-isobutylene diblock copolymer (SIB), styrene-butadiene-styrene triblock copolymer (SBS), styrene-ethylene/butene-styrene triblock copolymer (SEBS), styrene-ethylene/propylene-styrene triblock copolymer (SEPS), styrene-ethylene/ethylene/propylene-styrene triblock copolymer (SEEPS), and styrene-butadiene/butylene-styrene triblock copolymer (SBBS). The styrene thermoplastic elastomers may be used alone or in combination of two or more. Among these, styrene-vinylisoprene-styrene triblock copolymer is preferred because of its superior solvent resistance and chemical-resistant performance. Suitable examples of such styrene-vinylisoprene-styrene triblock copolymer include “FG1901 G Polymer” and “FG1924 G Polymer” available from KRATON CORPORATION and HYBRAR 5127 available from Kuraray Co., Ltd. The hydrogenated vinylisoprene block, HYBRAR 7311, available from Kuraray Co., Ltd. is also suitable.

The lower limit of the range of the amount of styrene block (styrene content) in the styrene thermoplastic elastomer is preferably 1% by mass, more preferably 5% by mass, and even more preferably 10% by mass of the total of styrene block and elastomer block. In this range, higher solvent resistance and chemical-resistant performance tend to be achieved. On the other hand, the upper limit is preferably 30% by mass and more preferably 20% by mass of the total of styrene block and elastomer block. In this range, solvent resistance and chemical-resistant performance tend to be more excellent.

The lower limit of the range of the amount of styrene thermoplastic elastomer in the resin composition containing polyolefin and a styrene thermoplastic elastomer is preferably 3% by mass, more preferably 5% by mass, and even more preferably 10% by mass of the total of polyolefin and styrene thermoplastic elastomer. In this range, higher solvent resistance and chemical-resistant performance tend to be achieved. On the other hand, the upper limit is preferably 30% by mass, more preferably 25% by mass, and even more preferably 20% by mass of the total of polyolefin and styrene thermoplastic elastomer. In this range, high solvent resistance and chemical-resistant performance tend to be achieved.

In the discharge assembly section 46, the joint portion that couples the tubes to each other may be formed of hard plastic (polypropylene) or the like.

The discharge device 50 is connected to the suction pipe section 41 and the discharge pipe section 42 of the vacuum piping 40 and is configured to send out gas from the suction pipe section 41 to the discharge pipe section 42. The discharge device 50 is communicatively connected to the respective reduced-pressure spaces S2 of the deaerating modules 10, 20, and 30 through the suction pipe section 41 and discharges the gas in the reduced-pressure spaces S2 from the discharge pipe section 42 to the outside based on control instructions from the control unit 80. The discharge device 50 includes, for example, a pump 51 and a fixing plate 52 to which the pump 51 is fixed. The pump 51 is fixed to an upper face 52a (the face opposite the bottom plate 2) of the fixing plate 52. Thus, a lower face 52b (the face closer to the bottom plate 2) of the fixing plate 52 is the lowest face (the face closest to the bottom plate 2) of the discharge device 50. The pump 51 includes a motor 53 for discharging the gas in the reduced-pressure spaces S2 to the outside, an intake port 54 to which the piping section 47 of the suction pipe section 41 is connected to suck the gas in the reduced-pressure spaces S2, and an exhaust port 55 to which the discharge pipe section 42 is connected to discharge the sucked gas to the outside of the deaerator 1. The motor 53 is rotationally driven based on control instructions from the control unit 80, and thereby the pump 51 sends out the gas in the reduced-pressure spaces S2 from the piping section 47 to the discharge pipe section 42 to discharge the gas from the discharge pipe section 42 to the outside. As the pump 51, for example, a diaphragm pump such as a diaphragm type dry vacuum pump is used. The diaphragm pump is a vacuum pump that moves a separation membrane (a diaphragm) up and down by rotationally driving a motor and moves a gas from an intake port to an exhaust port by this up and down movement of the separation membrane. As the fixing plate 52, for example, a rectangular metal plate or the like is used.

As illustrated in FIG. 1 and FIG. 2, the discharge device 50 is supported with respect to the bottom plate 2 of the housing 5 via four vibration isolating members 101. The four vibration isolating members 101 have the same configuration and will be described collectively as the vibration isolating member 101 except when they are specially described in a separate manner. The vibration isolating member 101 is a member for damping vibrations to suppress transmission of the vibrations. The vibration isolating member 101 is interposed between the bottom plate 2 and the discharge device 50 (the fixing plate 52) to support the discharge device 50 with respect to the bottom plate 2. The four vibration isolating members 101 are arranged at the four corners of the fixing plate 52 in a plan view and support the discharge device 50 (the fixing plate 52) at the four corners of the fixing plate 52. The discharge device 50 is arranged at a predetermined height from a top face 2a (the face closer to the discharge device 50) of the bottom plate 2 by the vibration isolating member 101.

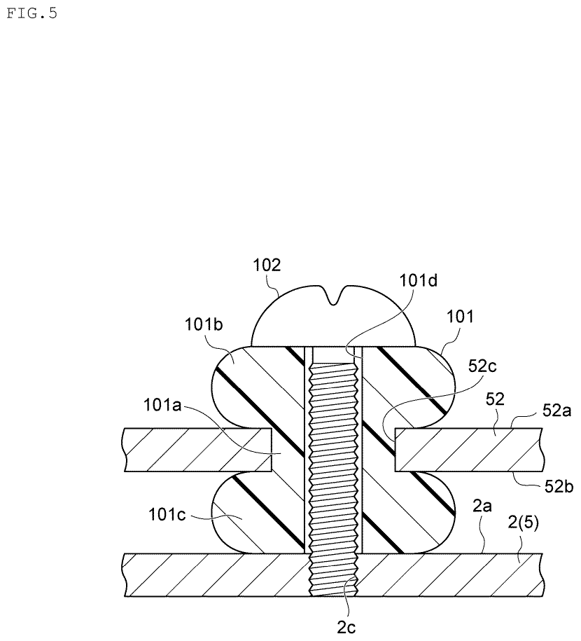

The vibration isolating member 101 has a configuration, for example, illustrated in FIG. 5. FIG. 5 is an enlarged cross-sectional view of a section around a vibration isolating member of the deaerator illustrated in FIG. 1. As illustrated in FIG. 5, the vibration isolating member 101 is interposed between the bottom plate 2 and the fixing plate 52 to support the fixing plate 52 with respect to the bottom plate 2. The vibration isolating member 101 has a neck portion 101a inserted into a through hole 52c of the fixing plate 52, an upper diameter-expanded portion 101b extending from the neck portion 101a toward the upper face 52a of the fixing plate 52 to be expanded, a lower diameter-expanded portion 101c extending from the neck portion 101a toward the lower face 52b of the fixing plate 52 to be expanded, and a through hole 101d passing through the neck portion 101a, the upper diameter-expanded portion 101b, and the lower diameter-expanded portion 101c. The upper diameter-expanded portion 101b and the lower diameter-expanded portion 101c are larger in diameter than the hole diameter of the through hole 52c of the fixing plate 52 so that they do not pass through the through hole 52c of the fixing plate 52. A screw 102 is inserted into the through hole 101d of the vibration isolating member 101 from the side closer to the upper face 52a of the fixing plate 52 and is screwed into a screw hole 2c of the bottom plate 2. With this, the upper diameter-expanded portion 101b and the lower diameter-expanded portion 101c put the fixing plate 52 therebetween from the side closer to the upper face 52a and the side closer to the lower face 52b, thus causing the lower diameter-expanded portion 101c to be pressed against the bottom plate 2 and causing the discharge device 50 to be supported with respect to the bottom plate 2 via the vibration isolating member 101. Note that the lower diameter-expanded portion 101c serves as a spacer between the fixing plate 52 and the bottom plate 2, thus arranging the fixing plate 52 so as to have a predetermined height from the bottom plate 2.

As illustrated in FIG. 1 and FIG. 2, the atmospheric release piping 60 is a member communicatively connected to the respective reduced-pressure spaces S2 of the deaerating modules 10, 20, and 30 to connect the reduced-pressure spaces S2 to the atmospheric release valve 70. The atmospheric release piping 60 has release piping sections 61, 62, and 63 continuous to the respective release ports 18a of the deaerating modules 10, 20, and 30, a release assembly section 64 for assembling the release piping sections 61, 62, and 63, and piping 65 connecting the release assembly section 64 to the atmospheric release valve 70. An end 66 opposite to the piping 65 of the release assembly section 64 of the atmospheric release piping 60 is closed. The atmospheric release piping 60 is formed of the same material as the vacuum piping 40, for example, resin tubes. More specifically, at least some of the release piping sections 61, 62, and 63, the release assembly section 64, and the piping 65 that constitute the atmospheric release piping 60 are formed of, for example, resin tubes as described above. All or almost all (e.g., excluding a joint portion) of the constituent members of the atmospheric release piping 60 may be formed of resin tubes. In other words, a plurality of resin tubes may be coupled using joint members or the like to constitute the atmospheric release piping 60. Such a resin tube is resistant to a solvent used in liquid chromatography and is formed of piping having a rubber hardness in the range of 70±30 degrees and an oxygen permeability of 6000 cc (STP) cm/cm²/sec/cmHg×10⁻¹⁰ or less. The joint portion of the release assembly section 64 may be formed of hard plastic (e.g., polypropylene) or the like, in the same manner as the joint portion of the discharge assembly section 46.

The atmospheric release valve 70 is a solenoid valve communicatively connected to one end of the atmospheric release piping 60 and capable of introducing the atmosphere into the respective reduced-pressure spaces S2 of the deaerating modules 10, 20, and 30 at once through the atmospheric release piping 60, based on control instructions from the control unit 80. When a deaerating process in the deaerating modules 10, 20, and 30 is finished, for example, the atmospheric release valve 70 opens the solenoid valve from the closed state (CLOSE) to the open state (OPEN) within five seconds, based on control instructions from the control unit 80, and opens the reduced-pressure spaces S2 (for example, 1 L containers) to the atmosphere within one minute.

The regulating valve 75 is a solenoid valve arranged between the deaerating modules 10, 20, and 30 and the discharge device 50 to regulate the degree of depressurization in the reduced-pressure spaces S2. The regulating valve 75 opens the valve when a depressurization process in the reduced-pressure spaces S2 by the discharge device 50 is being performed, and closes the valve based on control instructions from the control unit 80 when the degree of depressurization in the reduced-pressure spaces S2 falls within a predetermined range. In this case, the discharge device 50 can stop its discharge operation. On the other hand, when the degree of depressurization in the reduced-pressure spaces S2 subsequently falls outside the predetermined range, the valve is opened based on control instructions from the control unit 80. Both the atmospheric release valve 70 and the regulating valve 75 are raised to a predetermined height from the bottom plate 2 of the housing 5 by a plurality of legs 71 and a plurality of legs 76.

The control unit 80 controls the activation and deactivation of the pump 51 of the discharge device 50. The control unit 80 has the detector 90 to detect the degree of depressurization in the reduced-pressure spaces S2 and controls the operation of the discharge device 50 and the regulating valve 75 based on the detected degree of depressurization. In this control, the atmosphere is discharged by the discharge device 50 so that the degree of depressurization detected by the detector 90 attains a predetermined value, and when the degree of depressurization in the reduced-pressure spaces S2 falls within the predetermined range, the regulating valve 75 is closed and the operation of the discharge device 50 is stopped. When the degree of depressurization detected by the detector 90 falls outside the predetermined range after the regulating valve 75 is closed, the control unit 80 brings the discharge device 50 into operation again to perform a discharge process.

On the other hand, when the deaerating process is finished by the deaerating modules 10, 20, and 30, the control unit 80 controls the operation of the discharge device 50 and the atmospheric release valve 70 based on a stop instruction, for example, from the outside. In this control, after the deaerating process is finished, the atmospheric release valve 70 is opened to open the reduced-pressure spaces S2 to the atmosphere at once. After the deaerating process is finished, control may be performed such that the atmospheric release valve 70 is opened to open the reduced-pressure spaces S2 to the atmosphere at once while the gas discharge operation by the discharge device 50 continues for a predetermined time (e.g., a few seconds).

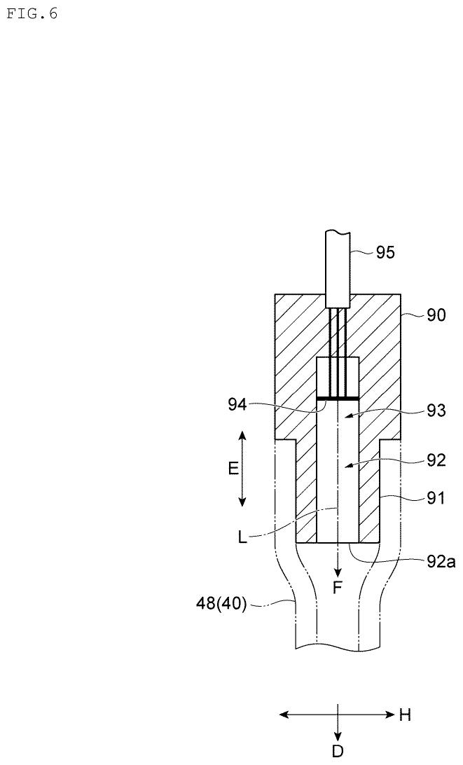

FIG. 6 is a schematic side view of a detector illustrated in FIG. 1. As illustrated in FIG. 6, the detector 90 has a connection nozzle portion 91 connected to the detection piping section 48 of the vacuum piping 40, a pressure introduction path 92 communicatively connected to the vacuum piping 40 through an opening 92a formed at the tip of the connection nozzle portion 91, a pressure detection space 93 communicatively connected to the pressure introduction path 92, and a pressure detection element 94 arranged in the pressure detection space 93.

The connection nozzle portion 91 is press-fit into the detection piping section 48 to be connected to the detection piping section 48. The connection nozzle portion 91 is formed in a shape that is easily press-fit into the detection piping section 48 and easily keeps airtightness between the connection nozzle portion 91 and the detection piping section 48, such as a cylindrical shape or conical shape.

The pressure introduction path 92 is a space communicatively connecting the vacuum piping 40 to the pressure detection space 83 to transmit pressure from the vacuum piping 40 to the pressure detection space 93. The pressure introduction path 92 is opened to the vacuum piping 40 by the opening 92a. The pressure introduction path 92 extends in a straight line along the connection nozzle portion 91 from the opening 92a formed at the tip of the connection nozzle portion 91. The direction in which the pressure introduction path 92 extends is referred to as an extension direction E. The extension direction E of the pressure introduction path 92 is, for example, the same as the extension direction of the connection nozzle portion 91. The inner diameter of the pressure introduction path 92 may vary in the extension direction E of the pressure introduction path 92 but is preferably the same throughout the entire area in the extension direction E of the pressure introduction path 92 from the viewpoint of efficiently transmitting pressure from the vacuum piping 40 to the pressure detection space 93 and ease of manufacture.

The pressure detection space 93 is a space adjacent to the side of the pressure introduction path 92 opposite the opening 92a. The pressure detection space 93 need not be clearly distinct from the pressure introduction path 92 and may be of any shape so long as it is adjacent to the side of the pressure introduction path 92 opposite the opening 92a. For example, when the detector 90 is formed with a cylindrical space extending cylindrically from the opening 92a formed at the tip of the connection nozzle portion 91, a partial space of this cylindrical space continuous from the opening 92a may be the pressure introduction path 92, while the remaining space of this cylindrical space may be the pressure detection space 93. When the detector 90 is formed with a cylindrical space extending cylindrically from the opening 92a formed at the tip of the connection nozzle portion 91, and a diameter-expanded space extending in a direction orthogonal to the extension direction E is formed on the side of this cylindrical space opposite the opening 92a, this cylindrical space may the pressure introduction path 92, while this diameter-expanded space may be the pressure detection space 93. Note that since the pressure detection element 94 is arranged, the pressure detection space 93 is preferably formed in a wide part of the detector 90 other than the connection nozzle portion 91 but may be formed in the connection nozzle portion 91 if the pressure detection element 94 is small.

The pressure detection element 94 is an element for detecting pressure, such as a diaphragm. The pressure detection element 94 is, for example, arranged such that a pressure receiving face of the diaphragm is exposed to the pressure detection space 93. The pressure detection element 94 electrically detects the amount of strain of the diaphragm to detect the pressure in the pressure detection space 93, that is, the degree of depressurization of the respective reduced-pressure spaces S2 of the deaerating modules 10, 20, and 30 communicatively connected to the pressure detection space 93. The pressure detection element 94 is, for example, arranged at a position overlapping the opening 92a as viewed from the extension direction E of the pressure introduction path 92. In other words, the pressure detection element 94 is arranged at a position visible from the opening 92a. Connected to the pressure detection element 94 is an output device 95 converting a detection value of the pressure detection element 94 into pressure information and outputting the pressure information to the control unit 80.

By the way, depending on the installation environment of the deaerator 1, a temperature difference may occur between the inside and outside of the detector 90 and vacuum piping 40, which may cause condensation inside the pressure introduction path 92 and the vacuum piping 40. If condensation occurs in the pressure introduction path 92, condensed water occurring in the pressure introduction path 92 may enter the pressure detection space 93 from the pressure introduction path 92. If condensation occurs in the vacuum piping 40, condensed water occurring in the vacuum piping 40 may flow to the pressure introduction path 92 and enter the pressure detection space 93 from the pressure introduction path 92. If liquid leaks from the tube unit to the reduced-pressure space due to deterioration of the tube unit or the like, leaking liquid, which is the liquid that has leaked, may flow from the vacuum piping 40 to the pressure introduction path 92 and enter the pressure detection space 93 from the pressure introduction path 92 by the activation of the discharge device.

Thus, to inhibit such liquids such as the condensed water and the leaking liquid from entering the pressure detection space 93 from the pressure introduction path 92, the opening 92a of the pressure introduction path 92 is directed downward D with respect to the horizontal direction H. In other words, the detector 90 is arranged in the deaerator 1 such that the opening 92a of the pressure introduction path 92 is directed downward D with respect to the horizontal direction H. The opening 92a of the pressure introduction path 92 being directed downward D with respect to the horizontal direction H refers to the opening 92a of the pressure introduction path 92 not being directed to the horizontal direction H and not being directed upward U with respect to the horizontal direction H. The opening 92a of the pressure introduction path 92 being directed downward D with respect to the horizontal direction H refers to, for example, a central axis line L of the pressure introduction path 92 directed from the pressure detection space 93 toward the opening 92a being directed downward D with respect to the horizontal direction H. The pressure introduction path 92 is directed downward D with respect to the horizontal direction H, that is, the central axis line L of the pressure introduction path 92 directed from the pressure detection space 93 toward the opening 92a is directed downward D with respect to the horizontal direction H, and thus the liquid in the pressure introduction path 92 travels through the pressure introduction path 92 to be discharged to the outside of the pressure introduction path 92 from the opening 92a by gravity.

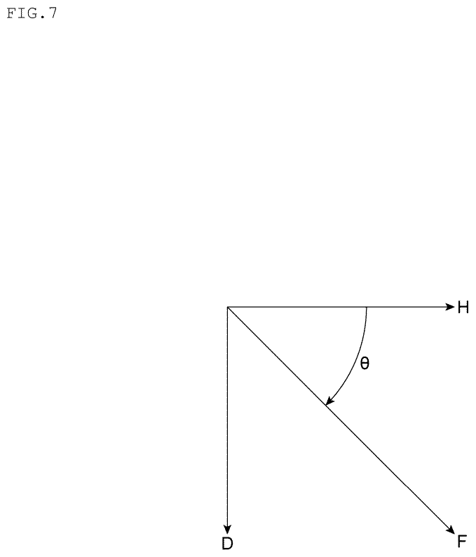

FIG. 7 is a diagram for illustrating a direction in which the opening 92a of the pressure introduction path 92 is directed. As illustrated in FIG. 6 and FIG. 7, the direction in which the aperture 92a of the pressure introduction path 92 is directed is defined as a direction F, and the inclination angle of the direction F toward the downward D with respect to the horizontal direction H is defined as an angle θ. The direction F is, for example, a direction in which the central axis line L of the pressure introduction path 92 directed from the pressure detection space 93 toward the opening 92a is directed. In this case, the angle θ is greater than 0°. The angle θ being greater than 0° refers to, for example, the central axis line L of the pressure introduction path 92 directed from the pressure detection space 93 toward the opening 92a being directed downward D with respect to the horizontal direction H at an angle of greater than 0°. The angle θ is greater than 0°, and thus the liquid in the pressure introduction path 92 travels through the pressure introduction path 92 to be discharged to the outside of the pressure introduction path 92 from the opening 92a by gravity.

From the viewpoint of being able to more discharge the liquid in the pressure introduction path 92 from the opening 92a, the opening 92a of the pressure introduction path 92 is preferably directed downward D by 10° or more with respect to the horizontal direction H, more preferably directed downward D by 45° or more with respect to the horizontal direction H, even more preferably directed downward D by 80° or more with respect to the horizontal direction H, and particularly preferably directed downward D by 89° or more with respect to the horizontal direction H. The central axis line L of the pressure introduction path 92 directed from the pressure detection space 93 toward the opening 92a is preferably directed downward D by 10° or more with respect to the horizontal direction H, more preferably directed downward D by 45° or more with respect to the horizontal direction H, even more preferably directed downward D by 80° or more with respect to the horizontal direction H, and particularly preferably directed downward D by 89° or more with respect to the horizontal direction H. The angle θ is preferably 10° or more, more preferably 45° or more, even more preferably 80° or more, and particularly preferably 89° or more. Note that FIG. 6, as an example, illustrates a case in which the opening 92a of the pressure introduction path 92 is directed downward D in the up and down direction UD (the vertical direction) and the angle θ is 90°.

As described above, in the deaerator 1 according to the present embodiment, the pressure detection element 94 of the detector 90 is arranged in the pressure detection space 93 communicatively connected to the vacuum piping 40 via the pressure introduction path 92, and thus the degree of depressurization of the reduced-pressure space S2 can be detected. The opening 92a of the pressure introduction path 92 is directed downward D with respect to the horizontal direction H, and thus even if condensed water occurs in the pressure introduction path 92 or condensed water occurring in the vacuum piping 40 flows to the pressure introduction path 92, these condensed waters are easily discharged to the outside of the pressure introduction path 92 from the opening 92a by gravity. This can inhibit condensed water from coming into contact with the pressure detection element 94. Even if the leaking liquid that has leaked from the tube unit 12 to the reduced-pressure space S travels through the vacuum piping 40 and flows to the pressure introduction path 92 by the activation of the discharge device 50, this leaking liquid is easily discharged to the outside of the pressure introduction path 92 from the opening 92a by gravity. This can inhibit the leaking liquid from coming into contact with the pressure detection element 94. Even if liquid enters the pressure detection space 93 from the pressure introduction path 92 or condensation occurs in the pressure detection space 93, the opening 92a of the pressure introduction path 92 is directed downward D with respect to the horizontal direction H, thus making it easy for the liquid in the pressure detection space 93 to travel through the pressure introduction path 92 and to be discharged from the opening 92a by gravity. This can inhibit liquid from coming into contact with the pressure detection element 94.

In this deaerator 1, the opening 92a of the pressure introduction path 92 is directed downward D with respect to the horizontal direction H by preferably 10° or more, more preferably 45° or more, even more preferably 80° or more, and particularly preferably 89° or more, thus making it easier to discharge the liquid from the pressure introduction path 92.

In this deaerator 1, the pressure introduction path 92 extends in a straight line, thus making it easier to discharge the liquid from the pressure introduction path 92.

In this deaerator 1, the central axis line L of the pressure introduction path 92 directed from the pressure detection space 93 toward the opening 92a is directed downward D with respect to the horizontal direction H, thus making it easier to discharge the liquid from the pressure introduction path 92.

In the deaerator 1, the pressure detection element 94 is arranged at the position overlapping the opening 92a as viewed from the extension direction E of the pressure introduction path 92, which can reduce the size of the detector 90 and detect the degree of depressurization of the reduced-pressure space S2 more efficiently.

In this deaerator 1, at least part of the vacuum piping 40 is a resin composition containing polyolefin and a styrene thermoplastic elastomer, which can provide excellent solvent resistance, chemical resistance, and durability. In addition, gas permeability can be reduced and disconnection of the vacuum piping 40 can be suppressed.

Although an embodiment of the present invention has been described above, the present invention is not limited to the foregoing embodiment and can be changed or modified as appropriate without departing from the spirit of the present invention.

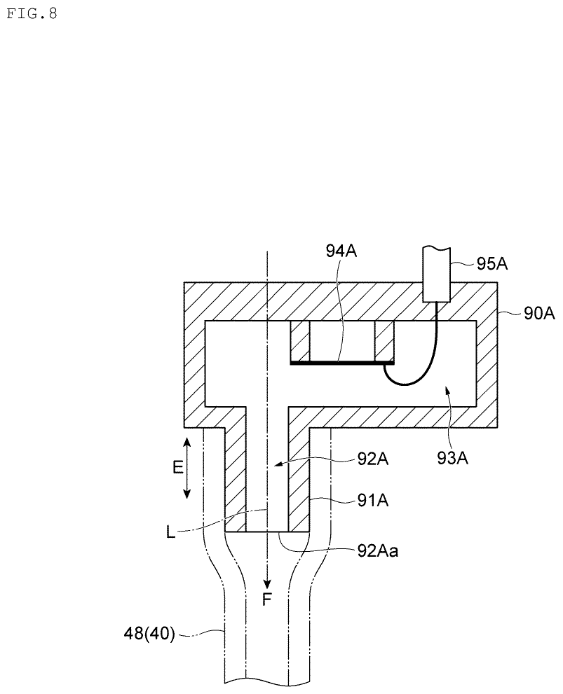

For example, as in a detector 90A illustrated in FIG. 8, the pressure detection element may be arranged at a position not overlapping the opening as viewed from the extension direction of the pressure introduction path. FIG. 8 is a schematic cross-sectional view of a detector as another example. The detector 90A illustrated in FIG. 8 has a connection nozzle portion 91A, a pressure introduction path 92A formed with an opening 92Aa at the tip of the connection nozzle portion 91A and communicatively connected to the vacuum piping 40, a pressure detection space 93A communicatively connected to the pressure introduction path 92A, and a pressure detection element 94A arranged in the pressure detection space 93A. The pressure detection space 93A extends long in a direction orthogonal to the extension direction E of the pressure introduction path 92A, and the pressure detection element 94A is arranged at a position in the pressure detection space 93A not overlapping the opening 92Aa as viewed from the extension direction E of the pressure introduction path 92A. Even in such a case, the opening 92Aa of the pressure introduction path 92A is directed downward D with respect to the horizontal direction H, thus making it easy for the liquid to be discharged to the outside of the pressure detection space from the opening 92Aa, and thus the liquid can be inhibited from coming into contact with the pressure detection element 94A.

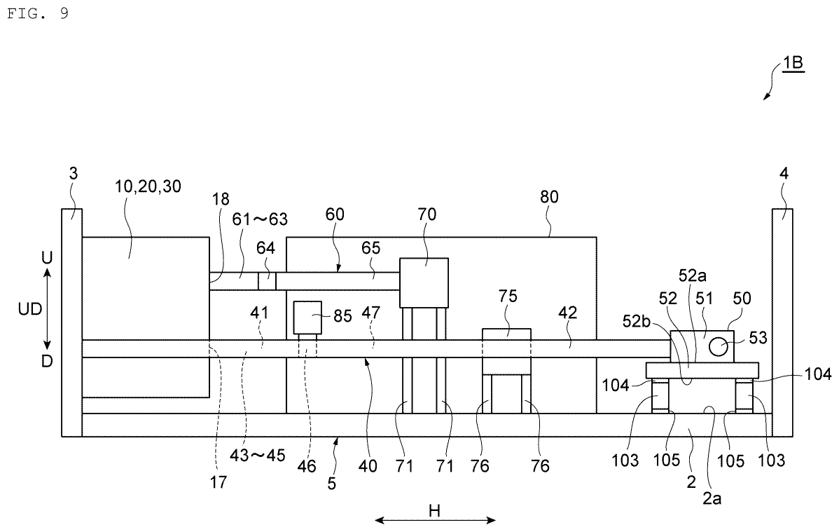

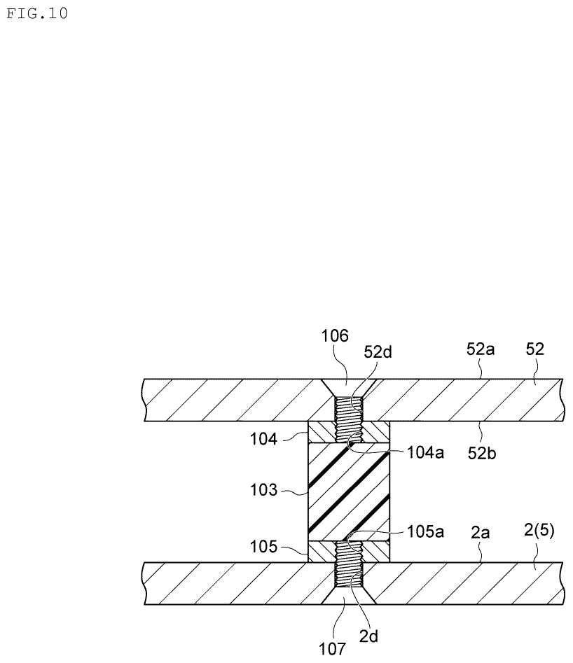

For example, the vibration isolating member is not necessarily directly mounted on the housing and the discharge device but may be mounted on the housing and the discharge device via other members. FIG. 9 is a schematic side view of a deaerator as another example. FIG. 10 is an enlarged cross-sectional view of a section around a vibration isolating member of the deaerator illustrated in FIG. 9. In this deaerator 1B illustrated in FIG. 9 and FIG. 10, this vibration isolating member 103 is formed in a columnar shape such as a cylinder or a square column. An upper plate 104 formed with a screw groove 104a is connected to an upper end, which is a tip on one side, of the vibration isolating member 103, and a lower plate 105 formed with a screw groove 105a is connected to a lower end, which is a tip on the other side, of the vibration isolating member 103. A screw 106 inserted into a through hole 52d of the fixing plate 52 is screwed into the screw groove 104a of the upper plate 104, thereby fixing the upper plate 104 to the fixing plate 52, and a screw 107 inserted into a through hole 2d of the bottom plate 2 is screwed into the screw groove 105a of the lower plate 105, thereby fixing the lower plate 105 to the bottom plate 2. With this, the vibration isolating member 103 is interposed between the bottom plate 2 of the housing 5 and the fixing plate 52 of the discharge device 50 to support the discharge device 50 with respect to the bottom plate 2 of the housing 5.

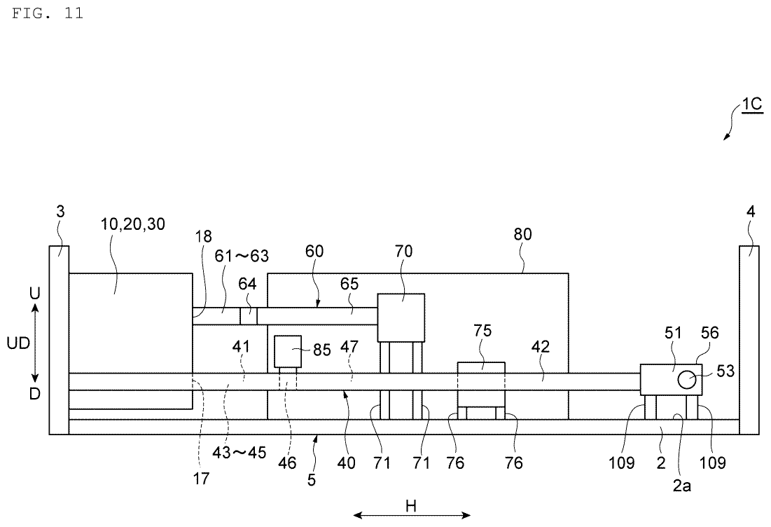

For example, the vibration isolating member is not necessarily mounted on the fixing plate of the discharge device and may be mounted on the pump of the discharge device. FIG. 11 is a schematic side view of a deaerator as another example. In this deaerator 1C illustrated in FIG. 11, this discharge device 56 has the same pump 51 as that of the above embodiment but does not have any configuration corresponding to the fixing plate of the above embodiment. This vibration isolating member 109 is mounted on the pump 51 and the bottom plate 2 directly or indirectly. The shape of the vibration isolating member 109 and the mounting structure of the vibration isolating member 109 to the pump 51 and the bottom plate 2 can be the same as, for example, the shape of the vibration isolating member 101 and the mounting structure of the vibration isolating member 101 to the fixing plate 52 and the bottom plate 2 illustrated in FIG. 5, the shape of the vibration isolating member 103 and the mounting structure of the vibration isolating member 103 to the fixing plate 52 and the bottom plate 2 illustrated in FIG. 10, or the like.

### INDUSTRIAL APPLICABILITY

The present invention can be used as a deaerator for use in liquid chromatography, gas chromatography, biochemical analyzers, inkjet filling apparatuses, and the like.

### REFERENCE SIGNS LIST

1, 1B, 1C deaerator
2 bottom plate
2a upper face
2c screw hole
2d through hole
3 front plate
4 rear plate
5 housing
10, 20, 30 deaerating module
11 tube
12 tube unit
12a inlet port
12b discharge port
13 housing
13a opening
14 lid
15 connector portion
16 connector portion
17 discharge nozzle portion
17a discharge port
18 release nozzle portion
18a release port
40 vacuum piping
41 suction pipe section
42 discharge pipe section
43, 44, 45 discharge piping section
46 discharge assembly section
47 piping section
48 detection piping section
50 discharge device
51 pump
52 fixing plate
52a upper face
52b lower face
52c through hole
52d through hole
53 motor
54 intake port
55 exhaust port
56 discharge device
60 atmospheric release piping
61, 62, 63 release piping section
64 release assembly section
65 piping
66 end
70 atmospheric release valve
71 leg
75 regulating valve
76 leg
80 control unit
83 pressure detection space
90, 90A detector
91 connection nozzle portion
92 pressure introduction path
92a opening
93, 93A pressure detection space
94, 94A pressure detection element
95 output device
101 vibration isolating member
101a neck portion
101b upper diameter-expanded portion
101c lower diameter-expanded portion
101d through hole
102 screw
103 vibration isolating member
104 upper plate
104a screw groove
105 lower plate
105a screw groove
106 screw
107 screw
109 vibration isolating member
S1 fluid circulation space
S2 reduced-pressure space
UD up and down direction
U upward
D downward
H horizontal direction
E extension direction
F direction
L central axis line
θ angle

1. A deaerator comprising:
a deaerating module having a tube unit having gas permeability, separating a fluid circulation space and a reduced-pressure space;
vacuum piping connected to the deaerating module to be communicatively connected to the reduced-pressure space of the deaerating module;
a discharge device connected to the vacuum piping to discharge a gas in the reduce-pressure space to the outside; and
a detector connected to the vacuum piping to detect pressure,
the detector comprising:
a connection nozzle portion connected to the vacuum piping;
a pressure introduction path extending from an opening formed at a tip of the connection nozzle portion to be communicatively connected to the vacuum piping;
a pressure detection space communicatively connected to the pressure introduction path; and
a pressure detection element arranged in the pressure detection space, and
the opening of the pressure introduction path being directed downward with respect to a horizontal direction.

2. The aerator according to claim 1, wherein the opening of the pressure introduction path is directed downward by 10° or more with respect to the horizontal direction.

3. The aerator according to claim 1, wherein the pressure introduction path extends in a straight line.

4. The aerator according to claim 1, wherein a central axis line of the pressure introduction path directed from the pressure detection space toward the opening is directed downward with respect to the horizontal direction.

5. The aerator according to claim 1, wherein the pressure detection element is arranged at a position overlapping the opening as viewed from an extension direction of the pressure introduction path.

6. The deaerator according to claim 1, wherein at least part of the vacuum piping is a resin composition containing polyolefin and a styrene thermoplastic elastomer.

7. The aerator according to claim 2, wherein the pressure introduction path extends in a straight line.

8. The aerator according to claim 2, wherein a central axis line of the pressure introduction path directed from the pressure detection space toward the opening is directed downward with respect to the horizontal direction.

9. The aerator according to claim 3, wherein a central axis line of the pressure introduction path directed from the pressure detection space toward the opening is directed downward with respect to the horizontal direction.

10. The aerator according to claim 7, wherein a central axis line of the pressure introduction path directed from the pressure detection space toward the opening is directed downward with respect to the horizontal direction.

11. The aerator according to claim 2, wherein the pressure detection element is arranged at a position overlapping the opening as viewed from an extension direction of the pressure introduction path.

12. The aerator according to claim 3, wherein the pressure detection element is arranged at a position overlapping the opening as viewed from an extension direction of the pressure introduction path.

13. The aerator according to claim 4, wherein the pressure detection element is arranged at a position overlapping the opening as viewed from an extension direction of the pressure introduction path.

14. The aerator according to claim 7, wherein the pressure detection element is arranged at a position overlapping the opening as viewed from an extension direction of the pressure introduction path.

15. The aerator according to claim 8, wherein the pressure detection element is arranged at a position overlapping the opening as viewed from an extension direction of the pressure introduction path.

16. The deaerator according to claim 2, wherein at least part of the vacuum piping is a resin composition containing polyolefin and a styrene thermoplastic elastomer.

17. The deaerator according to claim 3, wherein at least part of the vacuum piping is a resin composition containing polyolefin and a styrene thermoplastic elastomer.

18. The deaerator according to claim 4, wherein at least part of the vacuum piping is a resin composition containing polyolefin and a styrene thermoplastic elastomer.

19. The deaerator according to claim 5, wherein at least part of the vacuum piping is a resin composition containing polyolefin and a styrene thermoplastic elastomer.

20. The deaerator according to claim 7, wherein at least part of the vacuum piping is a resin composition containing polyolefin and a styrene thermoplastic elastomer.
